(19) United States
(12) Patent Application Publication
(10) Pub. No.: US 2019/0053663 A1
(43) Pub. Date: Feb. 21, 2019

(54) GRILL APPARATUS HAVING FOLDABLE HEAT GENERATING UNIT AND FOLDABLE GRILL UNIT

(71) Applicant: ZAIGLE CO., LTD., Seoul (KR)

(72) Inventor: Jin Hee Lee, Seoul (KR)

(73) Assignee: ZAIGLE CO., LTD., Seoul (KR)

(21) Appl. No.: 16/103,006

(22) Filed: Aug. 14, 2018

(30) Foreign Application Priority Data
Aug. 16, 2017 (KR) 10-2017-0103380

(51) Int. Cl. A47J 37/06; A47J 37/07

(52) U.S. Cl. CPC A47J 37/0635; A47J 37/0664; A47J 2037/0777; A47J 37/0736; A47J 37/0676

(57) ABSTRACT

Provided is a grill apparatus having a foldable heat generating unit and a grill unit, in which a plurality of heat sources are folded on each other or unfolded from each other, to radiate heat downward from the plurality of heat sources, and cook food through the plurality of heat sources, thereby controlling the amount and the time of cooking the food according to user's necessity by folding or unfolding the plurality of heat sources on each other or from each other. The grill apparatus includes: the foldable grill unit on which a food is put and cooked, in which a plurality of grill plates can be mutually unfolded or folded; and the foldable heat generating unit disposed on a support pillar disposed vertically from the grill unit and in which a plurality of heaters can be mutually unfolded or folded while applying infrared rays to the grill unit.

### TECHNICAL FIELD

The present disclosure relates to a grill apparatus having a foldable heat generating unit and a grill unit, and more particularly, to a grill apparatus having a foldable heat generating unit and a foldable grill unit, in which a plurality of heat sources are folded on each other or unfolded from each other, to radiate heat downward from the plurality of heat sources, and cook food to be cooked through the plurality of heat sources, thereby controlling the amount and the time of cooking the food according to user's necessity by folding the plurality of heat sources on each other or unfolding the plurality of heat sources from each other.

### CONVENTIONAL ART

Generally, a meat grill apparatus used to roast meat such as beef, pork, duck, or chicken is configured to place a grill or a meat grill plate over a charcoal or gas heater, and put meat on the grill or the meat grill plate to roast the meat.

In the case of using a grill, since a flame generated from a charcoal fire or a heater is directly applied to the meat, a partial burning phenomenon occurs even if the meat is turned over in a timely manner. According to the theories, the burnt meat contains many harmful substances such as carcinogenic substances, which may cause a problem reportedly when using such a grill. In addition, even when meat is roasted using a meat grill plate, the meat grill plate is heated while receiving heat from the heat source, to supposedly roast the meat on the grill plate. In this case, the surface of the meat contacting on the meat grill plate partly burns. As a result, the conventional meat grill apparatus as described above cannot completely solve the problem of burning meat.

In addition, when grilling meat using a grill or a meat grill plate as described above, it is often necessary to turn over the meat so that the front and back sides of the meat are evenly cooked. If such a turn-over of the meat is neglected, the meat is burned partially or totally.

As a result, cooking utensils such as frying pans were mainly used to grill pork, beef, chicken, duck, fish, etc. However, recently, in order to enjoy meat more deliciously, meat is put into a kiln made of loess, and is grilled with high heat and used for food.

Generally, when grilling meat or cooking food to then eat it, many people gather and eat the grilled meat or cooked food. When grilling meat or cooking food to be grilled, a frying pan or grill is used to grill the meat or cook the food to be grilled. By the way, when many people eat the grilled meat or food, it took a long time to cook the grilled meat or food. Accordingly, a large number of frying pans or grills are used to grill a large amount of meat or cook food to be grilled in a short time. However, even in this case, preparation or grilling of foods, and an after-use treatment process of the grill apparatus are complicated.

Further, in the case of a large number of frying pans or grills, it takes a lot of volume before and after use, which makes it difficult to store and move them.

### PRIOR ART DOCUMENT

Korean Utility Model Registration No. 20-0411296 (registered on Mar. 7, 2006)

### DISCLOSURE

### Technical Problem

The present disclosure has been conceived to solve the above problems, and it is an object of the present disclosure to provide a grill apparatus having a foldable heat generating unit and a foldable grill unit according to an aspect of the present disclosure, which is capable of setting the amount of using the grill unit and the foldable heat generating unit according to user's needs, thereby cooking a large amount of food to be grilled in a shorter time than the case of using a frying pan or grill.

It is another object of the present disclosure to provide a grill apparatus having a foldable heat generating unit or and a foldable grill unit, which is provided with a simple process of preparing or grilling food to be grilled while grilling a large amount of food to be grilled in a short time, and a convenient after-use treatment process.

It is still another object of the present disclosure to provide a grill apparatus having a foldable heat generating unit and a foldable grill unit, in which foods to be grilled can be grilled in a narrow space while a large amount of food can be grilled in a short time, and the grill apparatus can be kept in store conveniently before and after use it.

### Technical Solution

According to an aspect of the present disclosure, there is provided a grill apparatus having a foldable heat generating unit and a foldable grill unit, the grill apparatus comprising: the foldable grill unit 100 in which a plurality of grill plates can be mutually unfolded or folded and on which a cooking material to be cooked is placed and cooked; and the foldable heat generating unit 200 disposed on an upper portion of a support pillar 50 disposed vertically from the grill unit 100 and in which a plurality of heaters can be mutually unfolded or folded while applying infrared rays to the grill unit 100.

The grill unit 100 includes a main grill plate 110 on which food stuff to be cooked is put and cooked, and a first auxiliary grill plate 120 and a second auxiliary grill plate 130 which are rotatably connected to both sides of the main grill plate 110, respectively, and are stacked with the main grill plate 110 to be folded on each other. The heat generating unit 200 includes a main heater 210 for applying infrared rays to the main grill plate 110 so as to cook the food stuff on the main grill plate 110, and a first auxiliary heater 220 and a second auxiliary heater 230 which are rotatably connected to both sides of the main heater 210, respectively, in which infrared rays are applied to the first auxiliary grill plate 120 and the second auxiliary grill plate 130 and which are formed to be foldable with the main heater 210.

The grill unit 100 includes a first grill plate hinge 122 for allowing the first auxiliary grill plate 120 to rotate while being connected to one edge of the main grill plate 110, and a second grill plate hinge 132 for allowing the second auxiliary grill plate 130 to rotate while being connected to the other edge of the main grill plate 110.

The grill unit 100 includes an oil container 150 disposed at a lower portion of the main grill plate 110 and collecting oil generated and dropped from the main grill plate 110. The main grill plate 110 includes an oil hole 115 drilled at a central portion of the main grill plate 110 so that the oil generated while the food stuff to be grilled is cooked on the main grill plate 110 can be dropped on the oil container 150.

The oil container 150 includes a first auxiliary oil container 125 which is slid from the oil container 150 to a position where the first auxiliary grill plate 120 is disposed so that the oil generated during the cooking of the food stuff can be dropped into the oil container 150 while the first auxiliary grill plate 120 is unfolded from the main grill plate 110, and a second auxiliary oil container 135 which is slid from the oil container 150 to a position where the second auxiliary grill plate 130 is disposed so that the oil generated during the cooking of the food stuff can be dropped into the oil container 150 while the second auxiliary grill plate 130 is unfolded from the main grill plate 110. The first auxiliary grill plate 120 includes a first oil hole 123 formed in the first auxiliary grill plate 120 at a position adjacent to the main grill plate 110 so that the oil generated from the first auxiliary grill plate 120 can be dropped into the first auxiliary oil container 125. The second auxiliary grill plate 130 includes a second oil hole 133 formed in the second auxiliary grill plate 130 at a position adjacent to the main grill plate 110 so that the oil generated from the second auxiliary grill plate 130 can be dropped into the second auxiliary oil container 135.

When the grill unit 100 is folded, the first auxiliary grill plate 120 is folded on the second auxiliary grill plate 130 after the second auxiliary grill plate 130 is folded on top of the main grill plate 110. When the grill unit 100 is unfolded, the first auxiliary griddle plate 120 is first unfolded while being rotated at one edge of the main grill plate 110 and then the second auxiliary grill plate 130 is unfolded while being rotated at the other edge of the main grill plate 110.

The main grill plate 110 may be formed to be inclined downward from an edge portion of the main grill plate 110 to a central portion thereof, and the first auxiliary grill plate 120 and the second auxiliary grill plate 130 may be formed of the upper and lower surfaces which are concave from the edge, respectively.

The main heater 210 may include a box-shaped body 211 and a heating element 213 that is accommodated in the box-shaped body 211 and emits infrared rays. The first auxiliary heater 220 may include a box-shaped first auxiliary body 221 and a first auxiliary heating element 223 which is accommodated in the first auxiliary body 221 and emits infrared rays. The second auxiliary heater 230 may include a box-shaped second auxiliary body 231 and a second auxiliary heating element 233 which is accommodated in the second auxiliary body 231 and emits infrared rays.

The heat generating unit 200 may include a first heater hinge 222 for allowing the first auxiliary heater 220 to rotate while the first auxiliary heater 220 is connected to one edge of the main heater 210, and a second heater hinge 232 for allowing the second auxiliary heater 230 to rotate while the second auxiliary heater 230 is connected to the other edge of the main heater 210. The first auxiliary heater 220 may be disposed to correspond to the first auxiliary grill plate 120 to thus apply infrared rays to the first auxiliary grill plate 120. The second auxiliary heater 230 may be disposed in correspondence to the second auxiliary grill plate 130 to thus apply infrared rays to the second auxiliary grill plate 130.

The first heater hinge 222 may interconnect the upper edge of the first auxiliary heat 220 and the lower one edge of the main heater 210. The second heater hinge 232 may interconnect the upper edge of the second auxiliary heater 230 and the lower other edge of the main heater 210.

The first auxiliary heater 220 may include a first opening and closing reflector 226 configured to open and close a lower portion of the first auxiliary heater 220. The second auxiliary heater 230 may include a second opening and closing reflector 236 configured to open and close a lower portion of the second auxiliary heater 230. A sliding groove 215 may be provided in the main heater 210 after being drilled in the longitudinal direction of the main heater 210 at both sides of the main heater 210 for allowing the first auxiliary heater 220 and the second auxiliary heater 230 to be slidably engaged with or disengaged from the main heater 210. A sliding protrusion 225 may be provided in each of the first auxiliary heater 220 and the second auxiliary heater 230 to be slidably engaged with or disengaged from the sliding groove 215. A power button 260 may be included in the main heater 210, the first auxiliary heater 220, and the second auxiliary heater 230, respectively, for allowing a user to turn on or turn off the power of the heating element 213, the first auxiliary heating element 223, and the second auxiliary heating element 233 separately, respectively.

### BRIEF DESCRIPTION OF THE DRAWINGS

FIG. 1 is a view showing a grill apparatus having a foldable heat generating unit and a foldable grill unit according to an embodiment of the present disclosure.

FIG. 2 is a view showing a cross section according to FIG. 1.

FIG. 3 is a view showing rotation of a part of a foldable grill unit and a foldable heat generating unit of a grill apparatus provided with the foldable heat generating unit and the foldable grill unit.

FIG. 4 is a view showing a part of the grill unit and a part of the heat generating unit according to FIG. 3 are folded.

FIG. 5 is a view showing a grill apparatus having a foldable heat generating unit and a foldable grill unit according to an embodiment of the present disclosure.

FIG. 6 is a view showing an operation of an oil container according to FIG. 5.

FIG. 7 is a view showing a grill apparatus having a foldable heat generating unit and a foldable grill unit according to an embodiment of the present disclosure.

FIG. 8 is a view showing that the grill unit according to FIG. 7 is folded.

FIG. 9 is a view showing a grill apparatus having a foldable heat generating unit and a foldable grill unit according to another embodiment of the present disclosure.

FIG. 10 is a view showing a use state according to FIG. 9.

### BEST MODE

The following detailed description of the invention refers to the accompanying drawings, which illustrate, by way of example, specific embodiments in which the invention may be practiced. These embodiments are described in sufficient detail to enable those skilled in the art to practice the invention. It should be understood that the various embodiments of the present disclosure are different, but need not be mutually exclusive. For example, certain features, structures, and characteristics described herein may be implemented in other embodiments without departing from the spirit and scope of the invention in the context of an embodiment. It is also to be understood that the position or arrangement of the individual components within each disclosed embodiment may be varied without departing from the spirit and scope of the invention. The following detailed description is, therefore, not to be taken in a limiting sense, and the scope of the present disclosure is to be limited only by the appended claims, along with the full scope of equivalents to which the claims are entitled, as appropriate. In the drawings, like reference numerals refer to like or equivalent features throughout the several views, length and area, thickness, and the like, and their shapes may be exaggerated for convenience.

Hereinafter, preferred embodiments of the present disclosure will be described in detail with reference to the accompanying drawings, so that those skilled in the art can easily carry out the present disclosure.

In the following detailed description, as an example, a plurality of heat sources are irradiated downward while they are folded or unfolded. The food to be cooked is cooked through the plurality of heat sources, while the plurality of heat sources are folded or unfolded. The amount and the time of cooking the food according to user's necessity can be controlled. That is, it is needless to say that the technical configuration of the grill apparatus (particularly, the grill unit and the heat generating unit) including a foldable heat generating unit and a foldable grill unit can be equally applied.

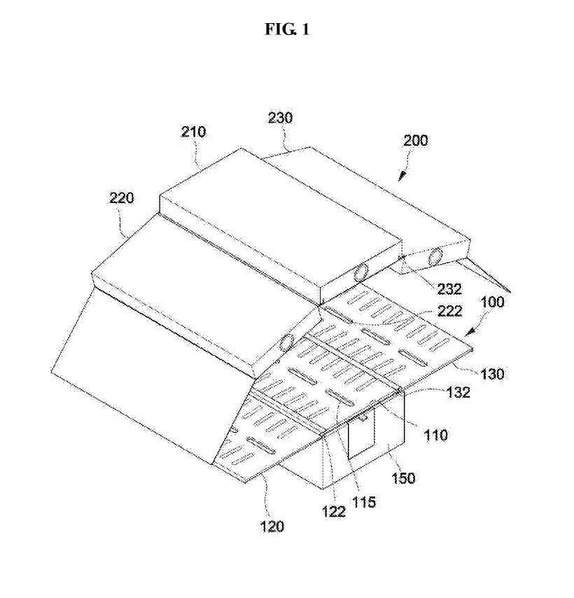

FIG. 1 is a view showing a grill apparatus having a foldable heat generating unit and a foldable grill unit according to an embodiment of the present disclosure.

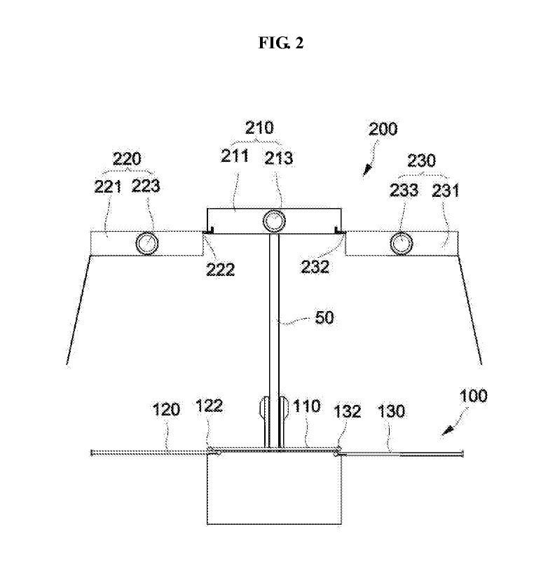

FIG. 2 is a view showing a cross section according to FIG. 1.

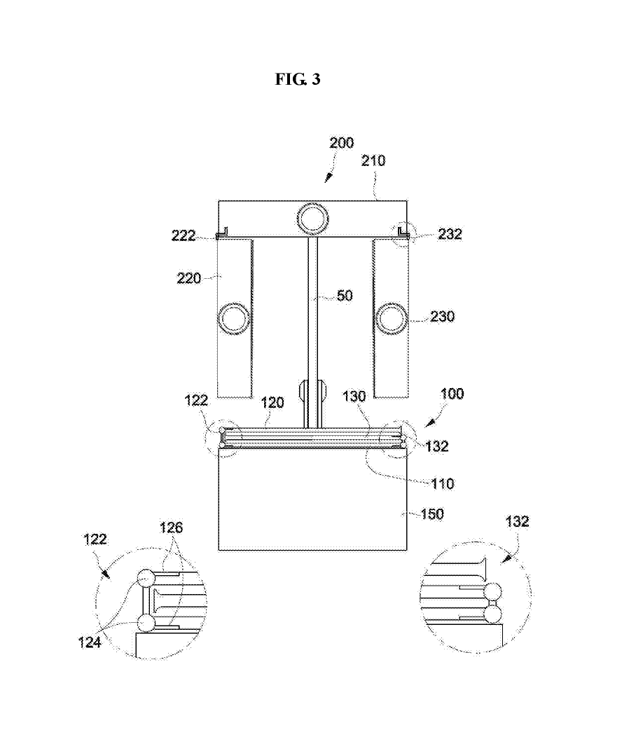

FIG. 3 is a view showing rotation of a part of a foldable grill unit and a foldable heat generating unit of a grill apparatus provided with the foldable heat generating unit and the foldable grill unit.

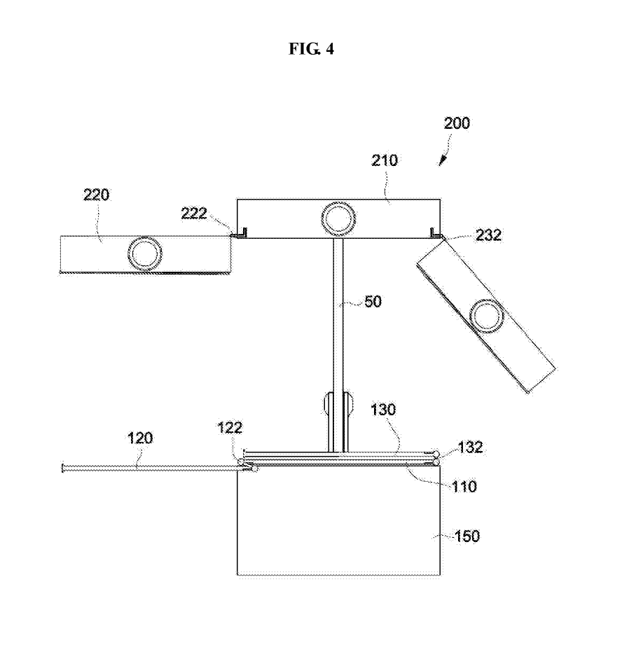

FIG. 4 is a view showing a part of the grill unit and a part of the heat generating unit according to FIG. 3 are folded.

Referring to FIGS. 1 to 4, a grill apparatus includes a foldable heat generating unit and a foldable grill unit. The grill apparatus includes the foldable grill unit 100 in which a plurality of grill plates can be mutually unfolded or folded; and the heat generating unit 200 in which a plurality of heaters are formed to be mutually unfolded or folded.

The grill unit 100 serves to support food stuffs to be grilled to grill food stuff to be grilled through heat sources applied from the heat generating unit 200 after having the food stuff to be grilled on the upper portion of the grill unit 100. The heat generating unit 200 applies infrared rays to the food stuff to be grilled in the grill unit 100 so that the food stuff to be grilled can be cooked. Here, the grill unit 100 is formed so that a plurality of grill plates can be mutually unfolded or folded while allowing a cooking material to be placed and cooked thereon. In addition, the heat generating unit 200 is formed to be disposed on an upper portion of a support pillar 50 disposed vertically from the grill unit 100 and in which a plurality of heaters can be mutually unfolded or folded while applying infrared rays to the grill unit 100. For this, the grill unit 100 includes a main grill plate 110 on which food stuff to be cooked is put and cooked, and a first auxiliary grill plate 120 and a second auxiliary grill plate 130 which are rotatably connected to both sides of the main grill plate 110, respectively, and are stacked with the main grill plate 110 to be folded on each other.

Further, the heat generating unit 200 includes a main heater 210 for applying infrared rays to the main grill plate 110 so as to cook the food stuff on the main grill plate 110, and a first auxiliary heater 220 and a second auxiliary heater 230 which are rotatably connected to both sides of the main heater 210, respectively, in which infrared rays are applied to the first auxiliary grill plate 120 and the second auxiliary grill plate 130 and which are formed to be foldable with the main heater 210.

Here, the main grill plate 110 of the grill unit 100 is disposed under the main heater 210 of the heat generating unit 200. The food stuff (hereinbelow, referred to as the food) to be grilled is put on the upper surface of the grill plate 110, so that the food to be grilled can be cooked through the heat source of the main heater 210.

The first auxiliary grill plate 120 is arranged to overlap with the main grill plate 110 and is rotated and unfolded in the main grill plate 110 in use. The first auxiliary grill plate 120 is arranged below the first auxiliary heater 220 which is rotated and unfolded in the main heater 210. Likewise, the second auxiliary grill plate 130 is arranged to overlap with the first auxiliary grill plate 120 and the main grill plate 110 and is rotated and unfolded in the main grill plate 110 in use, in a direction different from that of the first auxiliary grill plate 120. The second auxiliary grill plate 130 is arranged below the second auxiliary heater 230 which is rotated and unfolded in the main heater 210, in a direction different from that of the second auxiliary heater 230, to thereby grill the food to be grilled.

In this way, in order to allow the first auxiliary grill plate 120 and the second auxiliary grill plate 130 to smoothly be unfolded from the main grill plate 110, the grill unit 100 includes a first grill plate hinge 122 for allowing the first auxiliary grill plate 120 to rotate while being connected to one edge of the main grill plate 110, and a second grill plate hinge 132 for allowing the second auxiliary grill plate 130 to rotate while being connected to the other edge of the main grill plate 110.

Further, when the grill unit 100 is folded, the first auxiliary grill plate 120 is folded on the second auxiliary grill plate 130 after the second auxiliary grill plate 130 is folded on top of the main grill plate 110. Further, when the grill unit 100 is unfolded, the first auxiliary griddle plate 120 is first unfolded while being rotated at one edge of the main grill plate 110 and then the second auxiliary grill plate 130 is unfolded while being rotated at the other edge of the main grill plate 110.

As illustrated in FIG. 3, the first grill plate hinge 122 includes a plurality of first hinge shafts 124 and a plurality of first hinge plates 126 connected to each other. In the case that the first auxiliary grill plate 120 is unfolded from the second auxiliary grill plate 130, in a state where the former is folded on the latter, the unfolding operation can be performed smoothly. On the contrary, the first auxiliary grill plate 120 is folded on the second auxiliary grill plate 130 smoothly by the plurality of first hinge shafts 124 and the plurality of first hinge plates 126, to thus be stacked on the second auxiliary hinge plate 130. Similarly, the second grill plate hinge 132 also includes a plurality of second hinge shafts 134 and a plurality of second hinge plates 136 connected to each other. In the case that the second auxiliary grill plate hinge 130 is unfolded from the main grill plate 110, in a state where the former is folded on the latter, the unfolding operation can be performed smoothly.

The plurality of second hinge shafts 134 and the plurality of second hinge plates 136 allow the second auxiliary grill plate 130 to be folded on the main grill plate 110 smoothly to thus be stacked on the main grill plate 110.

Here, at a state where the main grill plate 110, and the first and second auxiliary grill plates 110 and 120 are folded on each other, to be stacked on each other, the length of one first hinge plate 126 disposed in the vertical direction from among the first hinge plates 126 is longer than the length of one second hinge plate 136 disposed in the vertical direction from among the second hinge plates 136.

That is, the first auxiliary grill plate 120 is connected to the main grill plate 110 by a first hinge shaft 124 and a first hinge plate 126 of the first grill plate hinge 122, to then be stacked on the upper surface of the second auxiliary grill plate 130 and to surround the second auxiliary grill plate 130. Therefore, the length of one first hinge plate 126 disposed in the vertical direction from among the first hinge plates 126 is longer than the length of one second hinge plate 136 disposed in the vertical direction from among the second hinge plates 136.

Further, the main grill plate 110 may be formed to be inclined downward from an edge portion of the main grill plate 110 to a central portion thereof, and the first auxiliary grill plate 120 and the second auxiliary grill plate 130 may be formed of the upper and lower surfaces that are concave from the edge, respectively.

According to an embodiment, the first auxiliary grill plate 130 is stacked on top of the main grill plate 110 when the grill unit 100 is initially used, and The first auxiliary grill plate 120 is stacked on the upper portion of the second auxiliary grill plate 130. Accordingly, the main heater 210 of the heat generating unit 200 can irradiate the upper surface of the first auxiliary grill plate 120 with infrared rays to grill food on the upper surface of the first auxiliary grill plate 120.

When the grill unit 100 is unfolded to use all of the main grill plate 110 and the first auxiliary grill plate 120 and the second auxiliary grill plate 130, the first auxiliary grill plate 120 is rotated and unfolded in the main grill plate 110 through the first grill plate hinge 122.

Further, the second auxiliary grill plate 130 is rotated and unfolded in the main grill plate 110 through the second grill plate hinge 132. In this case, the main heater 210 of the heat generating unit 200 irradiates infrared rays to the main grill plate 110, the first auxiliary heater 220 irradiates the first auxiliary grill plate 120 with infrared rays, and the second auxiliary heater 230 can irradiate infrared rays to the second auxiliary grill plate 130 to grill the respective foods.

As described above, it is preferable that the first and second auxiliary grill plates 120 and 130 be formed of the upper and lower surfaces which are concave from the edge of the first and second auxiliary grill plates 120 and 130 so that both surfaces the first and second auxiliary grill plates 120 and 130 can be used. That is, before the first auxiliary grill plate 120 is unfolded, the main heater 210 irradiates infrared lays on the upper surface of the first auxiliary grill plate 120, when the first auxiliary grill plate 120 is unfolded, the main heater 210 irradiates infrared lays on the upper surface of the second auxiliary grill plate 130, and when the second auxiliary grill plate 130 is unfolded, the main heater 210 irradiates infrared lays on the upper surface of the main grill plate 110.

In addition, when the use of the grill unit 100 is completed, the second auxiliary grill plate 130 is rotated so that the second auxiliary grill plate 130 is folded on top of the main grill plate 110 to then be stacked thereon for smooth storage. The first auxiliary grill plate 120 is rotated so that the first auxiliary grill plate 120 is folded on the upper portion of the second auxiliary grill plate 130 to then be stacked thereon, so as to be stored in a narrow space.

The grill unit 100 includes an oil container 150 disposed at a lower portion of the main grill plate 110 and collecting oil generated and dropped from the main grill plate 110. The main grill plate 110 includes an oil hole 115 drilled at a central portion of the main grill plate 110 so that the oil generated while the food stuff to be grilled is cooked on the main grill plate 110 can be dropped on the oil container 150. Accordingly, the oil generated as the food on the griddle plate 110 is grilled is collected through the oil container 150 while being dropped through the oil hole 115. Hereinafter, the oil container 150 will be described in more detail.

The main heater 210 of the heat generating unit 200 may include a box-shaped body 211 and a heating element 213 that emits infrared rays while being accommodated in the body 211, and the first auxiliary heater 220 may include a box-shaped first auxiliary body 221 and a first auxiliary heating element 223 that and emits infrared rays while being accommodated in the first auxiliary body 221.

The second auxiliary heater 230 may include a box-shaped second auxiliary body 231 and a second auxiliary heating element 233 that emits infrared rays while being accommodated in the second auxiliary body 231. Here, the body 211 surrounds the heating element 213 so that the heating element 213 can maintain its fixed position. The first auxiliary body 221 and the second auxiliary body 231 may also surround the first auxiliary heating element 223 and the second auxiliary heating element 233, respectively, so that the first auxiliary heating element 223 and the second auxiliary heating element 233 can be held in a fixed position, respectively.

The heat generating unit 200 may include a first heater hinge 222 for allowing the first auxiliary heater 220 to rotate while the first auxiliary heater 220 is connected to one edge of the main heater 210, and a second heater hinge 232 for allowing the second auxiliary heater 230 to rotate while the second auxiliary heater 230 is connected to the other edge of the main heater 210.

Further, the first auxiliary heater 220 may be disposed to correspond to the first auxiliary grill plate 120 to thus apply infrared rays to the first auxiliary grill plate 120, and the second auxiliary heater 230 may be disposed in correspondence to the second auxiliary grill plate 130 to thus apply infrared rays to the second auxiliary grill plate 130. The first heater hinge 222 may interconnect the upper edge of the first auxiliary heat 220 and the lower one edge of the main heater 210. The second heater hinge 232 may interconnect the upper edge of the second auxiliary heater 230 and the lower other edge of the main heater 210.

As a result, the first auxiliary heater 220 is rotated while being connected to the heater 210 via the first heater hinge 222, and the second auxiliary heater 230 is rotated while being connected to the main heater 210 via the second heater hinge 232.

In an embodiment, when the heating unit 200 is not used, the first auxiliary heater 220 and the second auxiliary heater 230 respectively connected to both sides of the main heater 210 are vertically disposed on both sides of the main heater 210 to be partially folded with the main heater 210. When only the main heater 210 is used in the heat generating unit 200, the first auxiliary heater 220 and the second auxiliary heater 230 are rotated at an angle of 10 degrees or more outward from the main heater 210 using the first heater hinge 222 and the second heater hinge 232. In this case, the heat source irradiated from the main heater 210 is reflected by the first auxiliary heater 220 and the second auxiliary heater 230 so that the heat source can be concentrated to the grill unit 100. When the main heater 210, the first auxiliary heater 220 and the second auxiliary heater 230 are both used, the first auxiliary heater 220 and the second auxiliary heater 230 are rotated at an angle of 90 degrees or more outward from the main heater 210 using the first heater hinge 222 and the second heater hinge 232. In this state, when the main grill plate 110 of the grill unit 100 and the first auxiliary grill plate 120 and the second auxiliary grill plate 130 are all unfolded, the main heater 210 is disposed on the upper portion of the main grill plate 110, the first auxiliary heater 220 is disposed on the upper portion of the first auxiliary grill plate 120, and the second auxiliary heater 230 is disposed on the upper portion of the second auxiliary grill plate 130, to thereby emit infrared rays, respectively.

When the use of the heat generating unit 200 is completed, the first auxiliary heater 220 and the second auxiliary heater 230 are rotated in the inner direction in which the main heater 210 is formed, and then the first auxiliary heater 220 and the second auxiliary heater 230 are disposed in a partially folded state with the main heater 210 by rotating.

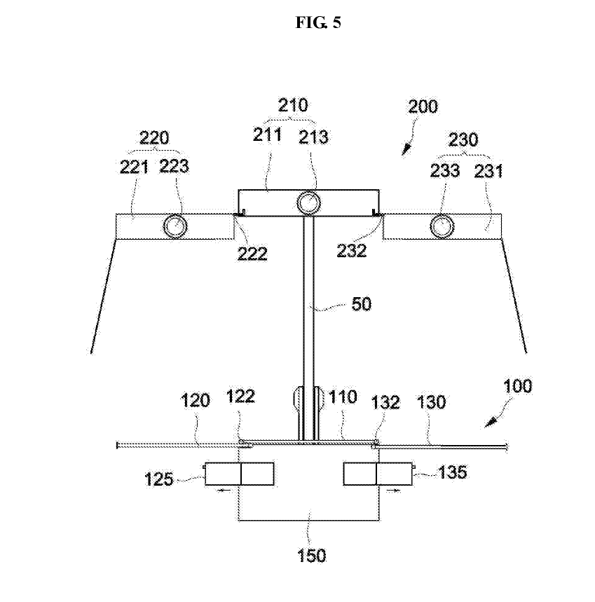

FIG. 5 is a view showing a grill apparatus having a foldable heat generating unit and a foldable grill unit according to an embodiment of the present disclosure.

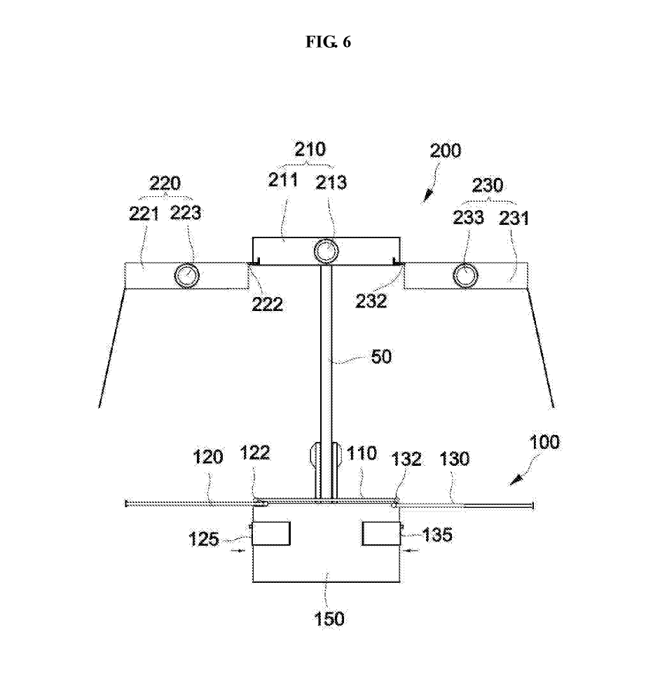

FIG. 6 is a view showing an operation of an oil container according to FIG. 5.

Referring to FIGS. 5 and 6, with reference FIGS. 1 to 4, a grill apparatus according to the present disclosure includes a foldable grill unit 100 and a foldable heat generating unit 200. The grill apparatus includes the foldable grill unit 100 in which a plurality of grill plates can be mutually unfolded or folded; and the foldable heat generating unit 200 in which a plurality of heaters can be mutually unfolded or folded.

The oil container 150 may include a first auxiliary oil container 125 which is slid from the oil container 150 to a position where the first auxiliary grill plate 120 is disposed so that the oil generated during the cooking of the food stuff can be dropped into the oil container 150 while the first auxiliary grill plate 120 is unfolded from the main grill plate 110.

The oil container 150 may include a second auxiliary oil container 135 which is slid from the oil container 150 to a position where the second auxiliary grill plate 130 is disposed so that the oil generated during the cooking of the food stuff can be dropped into the oil container 150 while the second auxiliary grill plate 130 is unfolded from the main grill plate 110.

The first auxiliary grill plate 120 may include a first oil hole 123 formed in the first auxiliary grill plate 120 at a position adjacent to the main grill plate 110 so that the oil generated from the first auxiliary grill plate 120 can be dropped into the first auxiliary oil container 125.

Further, the second auxiliary grill plate 130 may include a second oil hole 133 formed in the second auxiliary grill plate 130 at a position adjacent to the main grill plate 110 so that the oil generated from the second auxiliary grill plate 130 can be dropped into the second auxiliary oil container 135.

Here, when the first auxiliary grill plate 120 is unfolded and used from the main grill plate 110, the first auxiliary oil container 125 is slid from the oil rough 150 to a position where the first auxiliary grill plate 120 is disposed, and plays a role of receiving the oil dropped from the first auxiliary grill plate 120 and transmits the oil to the oil container 150.

That is, the oil dropped from the first auxiliary grill plate 120 to the first auxiliary oil container 125 flows into the oil container 150 from the first auxiliary oil container 125 and is collected in the oil container 150. For this, the first oil hole 123 drilled and formed in the first auxiliary grill plate 120 is formed to be positioned above the first auxiliary oil container 125 in a position adjacent to the main grill plate 110. Similarly, when the second auxiliary grill plate 130 is unfolded and used from the main grill plate 110, the second auxiliary oil container 135 is slid from the oil rough 150 to a position where the second auxiliary grill plate 130 is disposed, and plays a role of receiving the oil dropped from the second auxiliary grill plate 130 and transmits the oil to the oil container 150. That is, the oil dropped from the second auxiliary grill plate 130 to the second auxiliary oil container 135 flows into the oil container 150 from the second auxiliary oil container 125 and is collected in the oil container 150. For this, the second oil hole 133 drilled and formed in the second auxiliary grill plate 130 is formed to be positioned above the second auxiliary oil container 135 in a position adjacent to the main grill plate 110.

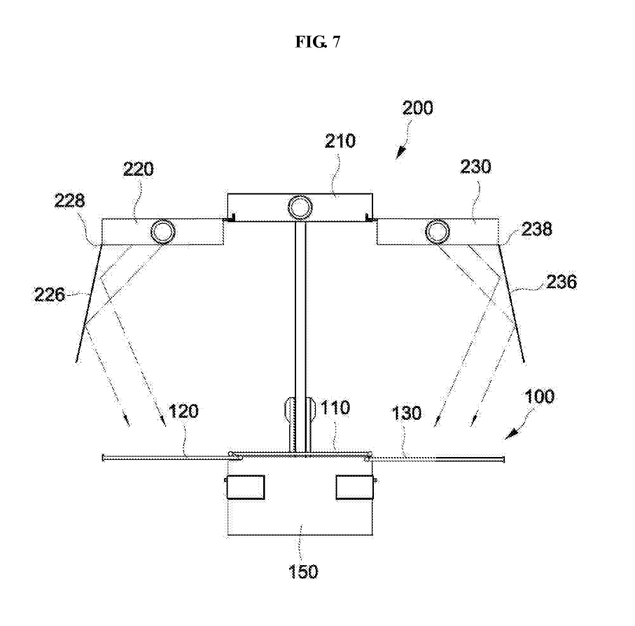

FIG. 7 is a view showing a grill apparatus having a foldable heat generating unit and a foldable grill unit according to an embodiment of the present disclosure.

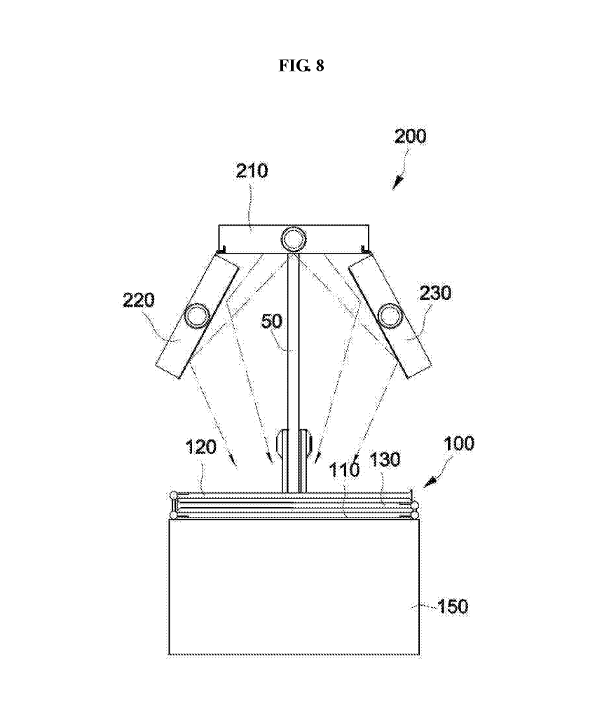

FIG. 8 is a view showing that the grill unit according to FIG. 7 is folded.

Referring to FIGS. 7 and 8, with reference FIGS. 1 to 4, a grill apparatus according to the present disclosure includes a foldable grill unit 100 and a foldable heat generating unit 200. The grill apparatus includes the foldable grill unit 100 in which a plurality of grill plates can be mutually unfolded or folded; and the foldable heat generating unit 200 in which a plurality of heaters can be mutually unfolded or folded.

As described above, the heat generating unit 200 includes a main heater 210 for applying infrared rays to the main grill plate 110 so as to cook the food stuff on the main grill plate 110, and a first auxiliary heater 220 and a second auxiliary heater 230 which are rotatably connected to both sides of the main heater 210, respectively, in which infrared rays are applied to the first auxiliary grill plate 120 and the second auxiliary grill plate 130 and which are formed to be foldable with the main heater 210.

In particular, the first auxiliary heater 220 may include a first opening and closing reflector 226 configured to open and close a lower portion of the first auxiliary heater 220, and the second auxiliary heater 230 may include a second opening and closing reflector 236 configured to open and close a lower portion of the second auxiliary heater 230. Here, the first opening and closing reflector 226 and the second opening and closing reflector 236 play a role of minimizing the emission of the infrared ray source radiated from the first auxiliary heater 220 and the second auxiliary heater 230 to the outside, and reflecting the infrared rays to the first and second auxiliary grill plates 120 and 130, respectively.

The first opening and closing reflector 226 is rotatably connected to a lower edge of the first auxiliary heater 220. For this, the first opening and closing reflector 226 is provided with a first hinge 228 that is rotatable while being connected with the first auxiliary heater 220.

Likewise, the second opening and closing reflector 236 is rotatably connected to a lower edge of the second auxiliary heater 230. Accordingly, the second opening and closing reflector 236 is provided with a second hinge 238 that is rotatable while being connected with the second auxiliary heater 230. Here, the first hinge 228 connects between the first opening and closing reflector 226 and the first auxiliary heater 220, and the second hinge 238 connects between the second opening and closing reflector 236 and the second auxiliary heater 230. It is preferable that the first opening and closing reflector 226 and the second opening and closing reflector 236 be rotated only by external pressurization.

That is, in order to rotate the first opening and closing reflector 226, a user may pressurize the first opening and closing reflector 226 to be rotated from the first auxiliary heater 220. When the pressurization is terminated, the first opening and closing reflector 226 is not rotated any more and is maintained in its fixed position. Similarly, in order to rotate the second opening and closing reflector 236, the user pressurizes the second opening and closing reflector 236 to be rotated from the second auxiliary heater 230, and when the pressurization is terminated, the second opening and closing reflector 236 is no longer rotated and remain in its fixed position.

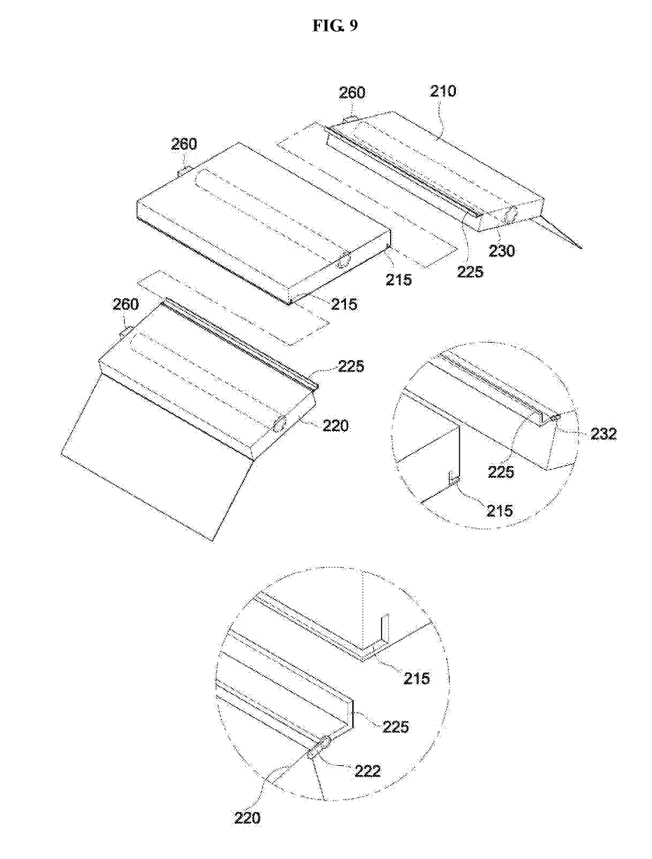

FIG. 9 is a view showing a grill apparatus having a foldable heat generating unit and a foldable grill unit according to another embodiment of the present disclosure.

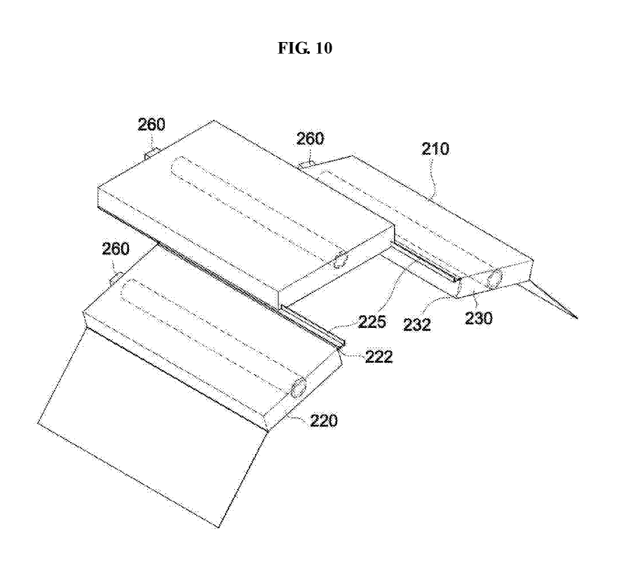

FIG. 10 is a view showing a use state according to FIG. 9.

Referring to FIGS. 9 and 10, with reference FIGS. 1 to 4, a grill apparatus according to the present disclosure includes a foldable grill unit 100 and a foldable heat generating unit 200. The grill apparatus includes the foldable grill unit 100 in which a plurality of grill plates can be mutually unfolded or folded; and the foldable heat generating unit 200 in which a plurality of heaters can be mutually unfolded or folded.

As described above, The heat generating unit 200 may include a first heater hinge 222 for allowing the first auxiliary heater 220 to rotate while the first auxiliary heater 220 is connected to one edge of the main heater 210, and a second heater hinge 232 for allowing the second auxiliary heater 230 to rotate while the second auxiliary heater 230 is connected to the other edge of the main heater 210. According to another embodiment, a sliding groove 215 may be provided in the main heater 210 after being drilled in the longitudinal direction of the main heater 210 at the lower portion of both sides of the main heater 210 for allowing the first auxiliary heater 220 and the second auxiliary heater 230 to be slidably engaged with or disengaged from the main heater 210, and a sliding protrusion 225 may be provided in each of the first auxiliary heater 220 and the second auxiliary heater 230 to be slidably engaged with or disengaged from the sliding groove 215. Here, the first heat generator hinge 222 may be provided between the first auxiliary heat generator 220 and the sliding protrusion 225.

In addition, the second heat generator hinge 232 may be provided between the second auxiliary heat generator 230 and the sliding protrusion 225. Accordingly, the first auxiliary heater 220 may be rotated while being connected to one side of the main heater 210 via the first heater hinge 222 with the sliding protrusion 225 being coupled to the sliding groove 215.

Further, the second auxiliary heater 230 may be rotated while being connected to the other side of the main heater 210 via the second heater hinge 232 with the sliding protrusion 225 being coupled to the sliding groove 215. The first auxiliary heater 220 and the second auxiliary heater 230 may be separated from the main heater 210 through the sliding groove 215 and the sliding protrusion 225, to then be kept in store, and when the first auxiliary heater 220 and the second auxiliary heater 230 are used, they can be easily combined and used with the main heater 210.

In particular, a power button 260 may be included in the main heater 210, the first auxiliary heater 220, and the second auxiliary heater 230, respectively, for allowing a user to turn on or turn off the power of the main heating element 213, the first auxiliary heating element 223, and the second auxiliary heating element 233 separately, respectively.

Accordingly, the main heater 210, the first auxiliary heater 220 and the second auxiliary heater 230 may be separately turned on and off through the power buttons 260 so that the use thereof can be smoothly performed. According to the above configuration, the amount of grilling of foods to be grilled can be adjusted according to the needs of the user, so that a plurality of grill plates and a plurality of heaters can be selectively used while using one grilling apparatus. In addition, the preparation and grilling process for grilling the foods to be grilled and the after-use treatment processing of the grill apparatus are convenient and easy to use it. In addition, since it can be used unfolded at the time of use and folded after use, it is possible to obtain a merit that can be easily used in a narrow place. While the present disclosure has been described in connection with what is presently considered to be practical exemplary embodiments, it is to be understood that the invention is not limited to the disclosed embodiments, but, on the contrary, it will be understood by those skilled in the art that the present disclosure may be embodied in other specific forms without departing from the spirit or essential characteristics thereof. It is therefore to be understood that the embodiments described above are illustrative in all aspects and not restrictive.

### ADVANTAGEOUS EFFECTS

A grill apparatus having a foldable heat generating unit and a foldable grill unit according to an embodiment of the present disclosure, has a technical effect of using a plurality of grill plates and heaters selectively with one grill apparatus so that the user can adjust the amount of food to be grilled according to the user's needs. A grill apparatus having a foldable heat generating unit and a foldable grill unit according to an embodiment of the present disclosure, provides the convenient preparation and grilling process for grilling the foods to be grilled and the easy after-use treatment processing of the grill apparatus, to thus provide an effect of easily using it.

A grill apparatus having a foldable heat generating unit and a foldable grill unit according to an embodiment of the present disclosure, has a technical effect of being easily used in a narrow place, in which it can be used unfolded at the time of use and folded after use.

What is claimed is:

1. A grill apparatus comprising: a foldable heat generating unit and a foldable grill unit,
the grill apparatus comprising the foldable grill unit 100 in which a plurality of grill plates can be mutually unfolded or folded; and
the foldable heat generating unit 200 disposed on an upper portion of a support pillar 50 disposed vertically from the grill unit 100 and in which a plurality of heaters can be mutually unfolded or folded while applying infrared rays to the grill unit 100,
wherein the grill unit 100 comprises a main grill plate 110 on which food stuff to be cooked is put and cooked, and a first auxiliary grill plate 120 and a second auxiliary grill plate 130 which are rotatably connected to both sides of the main grill plate 110, respectively, and are stacked with the main grill plate 110 to be folded on each other, and
wherein the heat generating unit 200 comprises a main heater 210 for applying infrared rays to the main grill plate 110 so as to cook the food stuff on the main grill plate 110, and a first auxiliary heater 220 and a second auxiliary heater 230 which are rotatably connected to both sides of the main heater 210, respectively, in which infrared rays are applied to the first auxiliary grill plate 120 and the second auxiliary grill plate 130 and which are formed to be foldable with the main heater 210,
wherein the first auxiliary heater 220 comprises
a first opening and closing reflector 226 formed to open and close a lower portion of the first auxiliary heater 220, and
wherein the second auxiliary heater 230 comprises
a second opening and closing reflector 236 formed to open and close a lower portion of the second auxiliary heater 230.

2. The grill apparatus of claim 1, wherein
the grill unit 100 includes a first grill plate hinge 122 for allowing the first auxiliary grill plate 120 to rotate while being connected to one edge of the main grill plate 110, and a second grill plate hinge 132 for allowing the second auxiliary grill plate 130 to rotate while being connected to the other edge of the main grill plate 110.

3. The grill apparatus of claim 1, wherein
the grill unit 100 includes an oil container 150 disposed at a lower portion of the main grill plate 110 and collecting oil generated and dropped from the main grill plate 110, and
the main grill plate 110 includes an oil hole 115 drilled at a central portion of the main grill plate 110 so that the oil generated while the food stuff to be grilled is cooked on the main grill plate 110 can be dropped on the oil container 150.

4. The grill apparatus of claim 3, wherein
the oil container 150 includes a first auxiliary oil container 125 which is slid from the oil container 150 to a position where the first auxiliary grill plate 120 is disposed so that the oil generated during the cooking of the food stuff can be dropped into the oil container 150 while the first auxiliary grill plate 120 is unfolded from the main grill plate 110, and
a second auxiliary oil container 135 which is slid from the oil container 150 to a position where the second auxiliary grill plate 130 is disposed so that the oil generated during the cooking of the food stuff can be dropped into the oil container 150 while the second auxiliary grill plate 130 is unfolded from the main grill plate 110,
wherein the first auxiliary grill plate 120 includes a first oil hole 123 formed in the first auxiliary grill plate 120 at a position adjacent to the main grill plate 110 so that the oil generated from the first auxiliary grill plate 120 can be dropped into the first auxiliary oil container 125, and
the second auxiliary grill plate 130 includes a second oil hole 133 formed in the second auxiliary grill plate 130 at a position adjacent to the main grill plate 110 so that the oil generated from the second auxiliary grill plate 130 can be dropped into the second auxiliary oil container 135.

5. The grill apparatus of claim 1, wherein,
when the grill unit 100 is folded, the first auxiliary grill plate 120 is folded on the second auxiliary grill plate 130 after the second auxiliary grill plate 130 is folded on top of the main grill plate 110, and when the grill unit 100 is unfolded, the first auxiliary griddle plate 120 is first unfolded while being rotated at one edge of the main grill plate 110 and then the second auxiliary grill plate 130 is unfolded while being rotated at the other edge of the main grill plate 110, and
the main grill plate 110 is formed to be inclined downward from an edge portion of the main grill plate 110 to a central portion thereof, and
the first auxiliary grill plate 120 and the second auxiliary grill plate 130 are formed of the upper and lower surfaces which are concave from the edge, respectively.

6. The grill apparatus of claim 1, wherein
the main heater 210 includes a box-shaped body 211 and a heating element 213 that is accommodated in the box-shaped body 211 and emits infrared rays, and
the first auxiliary heater 220 includes a box-shaped first auxiliary body 221 and a first auxiliary heating element 223 which is accommodated in the first auxiliary body 221 and emits infrared rays, and
the second auxiliary heater 230 includes a box-shaped second auxiliary body 231 and a second auxiliary heating element 233 which is accommodated in the second auxiliary body 231 and emits infrared rays.

7. The grill apparatus of claim 1, wherein
the heat generating unit 200 includes a first heater hinge 222 for allowing the first auxiliary heater 220 to rotate while the first auxiliary heater 220 is connected to one edge of the main heater 210, and a second heater hinge 232 for allowing the second auxiliary heater 230 to rotate while the second auxiliary heater 230 is connected to the other edge of the main heater 210,
the first auxiliary heater 220 is disposed to correspond to the first auxiliary grill plate 120 to thus apply infrared rays to the first auxiliary grill plate 120, and
the second auxiliary heater 230 is disposed in correspondence to the second auxiliary grill plate 130 to thus apply infrared rays to the second auxiliary grill plate 130.

8. The grill apparatus of claim 7, wherein
the first heater hinge 222 interconnects the upper edge of the first auxiliary heat 220 and the lower one edge of the main heater 210, and
the second heater hinge 232 interconnects the upper edge of the second auxiliary heater 230 and the lower other edge of the main heater 210.

9. The grill apparatus of claim 1, wherein
a sliding groove 215 is provided in the main heater 210 after being drilled in the longitudinal direction of the main heater 210 at the lower portion of both sides of the main heater 210 for allowing the first auxiliary heater 220 and the second auxiliary heater 230 to be slidably engaged with or disengaged from the main heater 210, and
a sliding protrusion 225 is provided in each of the first auxiliary heater 220 and the second auxiliary heater 230 to be slidably engaged with or disengaged from the sliding groove 215.

10. The grill apparatus of claim 6, wherein
a power button 260 is included in the main heater 210, the first auxiliary heater 220, and the second auxiliary heater 230, respectively, for allowing a user to turn on or turn off the power of the heating element 213, the first auxiliary heating element 223, and the second auxiliary heating element 233 separately, respectively.
